(19) United States
(12) Patent Application Publication
(10) Pub. No.: US 2007/0229878 A1
(43) Pub. Date: Oct. 4, 2007

(54) Method for managing and executing print jobs by using sub-jobs

(75) Inventors: Rakesh Pandit, Irvine, CA (US); Toshiro Fujimori, Laguna Beach, CA (US); Sam Chan, West Covina, CA (US)

Correspondence Address: YING CHEN;Chen Yoshimura LLP, 255 S. GRAND AVE., # 215, LOS ANGELES, CA, 90012, US

(73) Assignee: Konica Minolta Systems Laboratory, Inc.

(21) Appl. No.: 11/395,518

(22) Filed: Mar. 31, 2006

(51) Int. Cl. G06F 3/12

(52) U.S. Cl. 358/1.15

(57) ABSTRACT

A method used in a print shop for managing a print job submitted by a customer is described. The print shop includes a plurality of printers connected to a server and a client computer. The server generates a main job ticket based on the customer-submitted print job, and generates a plurality of sub-job tickets based on the main job ticket. The sub-jobs defined by the sub-job tickets collectively accomplish the print job submitted by the customer. The server maintains a database that stores the main job ticket and the sub-job tickets in association with the corresponding main job ticket. The server also monitors the status of the sub-jobs and updates the status of the main job ticket on a user interface of a client computer. When all the sub-jobs are complete, the main job ticket is displayed in the user interface as being complete.

### BACKGROUND OF THE INVENTION

1. Field of the Invention

This invention relates to a method and apparatus for managing a print shop system in which a plurality of printers are connected to and managed by a server. In particular, it relates to a method and apparatus for managing and executing print requests from customers.

2. Description of Related Art

A professional print shop typically has a plurality of printers connected to a server by a network, where the server controls the printing of customer jobs on one or more printers. A print request received from a customer often requires the employment of two or more printers or other machines (such as a finishing machine) to complete. Print shop management software has been developed to manage the printers and other machines in a print shop and to manage print requests from customers.

### SUMMARY OF THE INVENTION

The present invention is directed to a method of managing print jobs that require more than one printer and/or other machine to complete by using sub-jobs.

An object of the present invention is to provide a method that manages such print jobs in a manner that is convenient and easy to use for the operator.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other objects, as embodied and broadly described, the present invention provides a method for managing print jobs in a print shop system, the print shop system including a plurality of document handling machines, the method being implemented on a server connected to the document handling machines, where the method includes: receiving a print request from a customer; obtaining a main job ticket for the print request; generating, based on the main job ticket, a plurality of sub-job tickets each defining a sub-job to be executed by a document handling machine, the plurality of sub-jobs collectively fulfilling the received print request; storing the main job ticket and the sub-job tickets in a database in association with each other; and executing the plurality of sub-jobs defined by the plurality of sub-job tickets.

In another aspect, the present invention provides a computer program product that causes a data processing apparatus to perform the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates the relationship between a main job ticket and a plurality of sub-job tickets.

FIG. 2 is a flow chart illustrating a method for managing print jobs according to an embodiment of the present invention.

FIG. 3 schematically illustrates a print shop system having a plurality of printers connected to a server via a network in which methods according to embodiments of the present invention may be implemented.

### DETAILED DESCRIPTION OF THE PREFERRED EMBODIMENTS

FIG. 3 schematically shows a print shop system 1 having a plurality of document handling machines 2a, 2b, . . . such as printers, scanners, finishing machines, or the like, connected to a server (or any suitable data processing apparatus) 3 via a network 4. One or more client computers 5 are also connected to the server to enable print shop operators to interact with the server and the rest of the system via a user interface. The server 3 is preferably also connected to an external network 6 such as the Internet for receiving print jobs (i.e. print requests from customers and documents to be printed). The server 3, under the control of print shop management software, receives print jobs from customers and submits print commands and data to be printed to one or more machines 2. The print shop management software may make various management decisions, such as which printer(s) to use for a print job, either automatically or under various degree of control of an operator.

The server 3 accepts print jobs from external or internal users. For each print job, the server maintains a job ticket (hereinafter referred to as the main job ticket), which contains a set of parameters that define the various printing requirements for the job, such as the number of copies, orientation, input tray, output tray, finishing instructions (staple, hole punch, etc.), etc. To execute the print job, the server interprets the main job ticket to generate several server-defined sub-job processes. For each of these job processes the server maintains a job ticket, referred to as the sub-job ticket, which contains parameters that define the sub-job process. The server then executes these sub-job processes until completion, which will accomplish the user requested print job.

One example of a print job that requires interpretation of a main job ticket to generate several sub-job tickets is color splitting, which is carried out when a document to be printed contains both color and black and white pages. Since color pages are more costly to print, it is desirable to separate such a document into a color sub-document to be printed on a color printer and a black and white sub-document to be printed on a black and white printer, and merge the two sets of printouts into a final document. To accomplish color splitting, the server splits the print job into two sub-jobs, one for color printing and one for black and white printing, based on the main job ticket. A commonly owned, co-pending U.S. patent application entitled “Method for Printing Mixed Color and Black and White Documents” (Attorney docket 75675.B084), which is incorporated by reference herein in its entirety, describes exemplary methods for splitting a main job ticket into a color and a black and white sub-job tickets. The server first prints a first sub-job (e.g. the color sub-job); then, after the first sub-job has printed, the operator transports the printed pages to a paper inserter unit of the second printer. A paper inserter unit is a feeder in a printer that feeds the paper in it to the output tray of the printer, without printing on them, in a programmed order concurrently with the printing of another document by the printer. The server then prints second sub-job on the second printer, whereby the output of the first sub-job is merged with that of the second sub-job to produce the printed document that contains both color and black and white pages.

Another example of a print job that requires interpretation of user-submitted main job ticket to generate several sub-job tickets is banner page printing. A banner page is a printed page or pages that provide information about the print job. For example, the printed banner page may include job ticket information, such as job name, job ticket number, document name, etc. Additionally the banner page may have machine counter information that may be used by the print shop for accounting purposes. For a submitted job that requires a banner page, the server generates a banner page printing sub-job ticket associated with the main job. Yet another example is off-line instruction sheet printing. Similar to banner page printing, the server may need to print an off-line instruction sheet for the submitted job. The on-line instruction sheet contains information obtained from job ticket fields, and informs the operator about off-line finishing requirements (i.e. finishing tasks such as hole punch, binding, etc. that are performed by machines other than the printer that prints the job) for the user-submitted job. The server generates a sub-job ticket for the off-line instruction sheet sub-job.

In order to handle the above cases, and other situations when sub-jobs need to be created, the server is provided with a mechanism to associate more than one printing sub-jobs for each user-submitted main job. Embodiments of the present invention provide a method implemented on the server for creating, associating and processing a sequence of sub-job processes for a main job. The method also provides an interface with the operator to allow the operator to monitor and manage the main job without having to be concerned with the sub-job tickets.

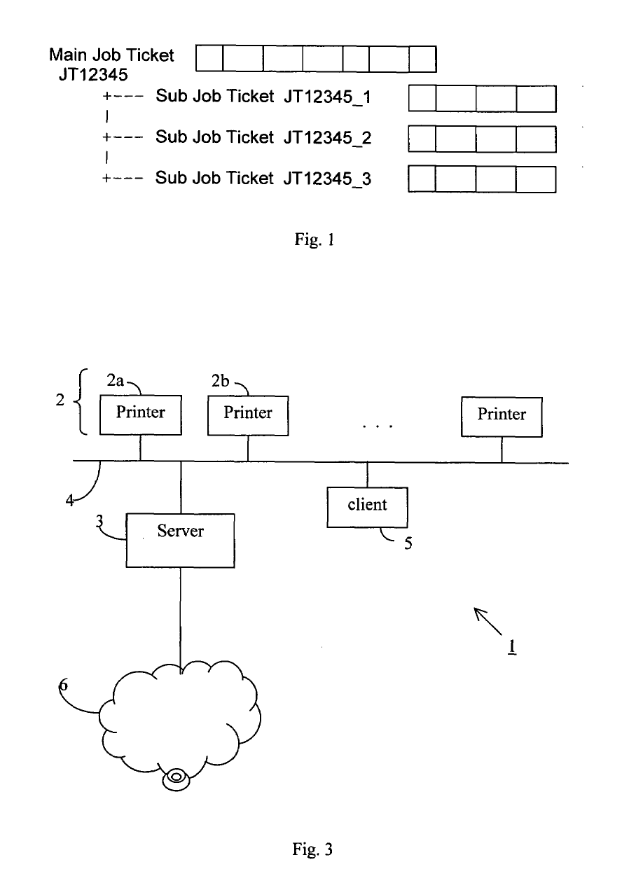

To manage the sub-jobs, the server maintains a database that stores the main job tickets and the sub-job tickets in association with the corresponding main job tickets. Each main job ticket is given a conventional identifier, such as “JT12345”. The sub-job tickets associated with the main job ticket are given identifiers that use the main job ticket identifier as a prefix, with suffixes added to identify the different sub-jobs, such as JT12345_1, JT12345_2, etc. FIG. 1 schematically illustrates the relationship between a main job ticket and a plurality of sub-job tickets associated with the main job ticket.

In one particular embodiment, the server persists each main job ticket in the database as a single database row in a database table called the main job ticket table. Multiple rows in the table represent multiple job tickets. A “job ticket number” field is the key field of the job ticket data that is used as an index into the database table to allow the main job tickets in the database table to be located quickly. For each type of sub-job ticket a type table is created during database initialization. The complete set of types of sub-job tickets is known when the database is initialized. The sub-job ticket type tables have the same basic structure, which includes a main job ticket number field and a sub-job ticket Id field. The sub-job ticket Id is unique within the set of sub-job tickets for the main job ticket number. It is used with the ticket number field to produce the key. To efficiently maintain the execution order of the sub-job tickets within a main job ticket, a sub-job ticket ordering table is used. This table has the following structure:

TABLE 1

| Field name | Description |
|---|---|
| Main Job Ticket | This is the Main Job Ticket Number. This allows up to |
| Number | 255 characters for the job ticket number to be |
| | identified. This column, in conjunction with the next, |
| | is marked as the primary key. |
| orderNumber | Defines the order of the sub-job ticket processing |
| | within the main job ticket. |
| tableName | The name of the type table holding the sub-job ticket. |
| subJobTicketId | This identifier is unique within the set of sub-job |
| | tickets for the job ticket number. |

The sub-job tickets are generated by defining their parameter values based on the parameter values of the corresponding main job ticket and other considerations. For example, in the color split example given above, the sub-job tickets are for printing the color pages and the black and white pages, respectively, of the original document. Some parameters of the main job ticket will be carried over to both the color and the black and white sub-job tickets, such as the number of copies, print orientation, output paper size, etc.; some parameters will be carried over to only one of the sub-job tickets, such as input and output trays, finishing options, etc., and some parameters that are associated with specific pages of the document will be carried to the sub-job ticket for the sub-job that contains that page, etc. As mentioned earlier, the commonly owned, co-pending U.S. patent application entitled “Method for Printing Mixed Color and Black and White Documents” describes exemplary methods for splitting a main job ticket into a color sub-job ticket and a black and white sub-job ticket. In the banner page printing and off-line instruction sheet printing examples, the server will generate the sub-job tickets that specify the printing of banner page or instruction sheet.

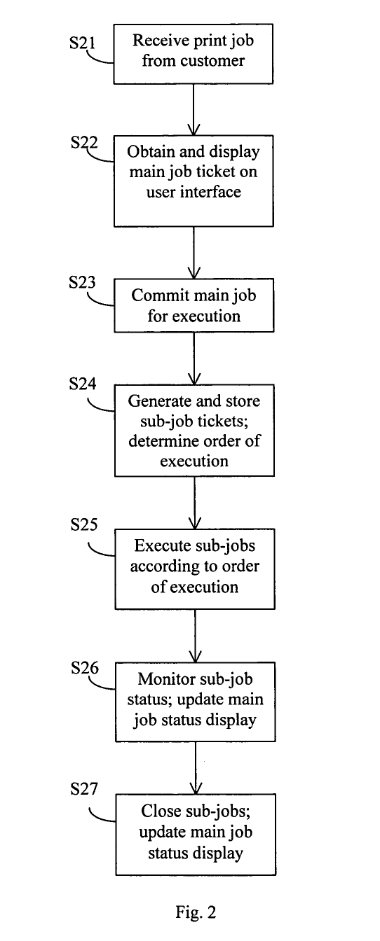

FIG. 2 illustrates a method of managing and executing print jobs submitted by customers according to an embodiment of the present invention. The method may be implemented on a server in a print shop system such as that shown in FIG. 3. When the server 3 receives a print job submitted by a customer (e.g. from one of the client computers in the print shop, or via the external network) (step S21), the server obtains a main job ticket, stores it in the database, assigns it a main job ticket identifier and displays the identifier on the user interface of the client 5 (step S22). In step S22, the main job ticket may be received from the customer, or generates by the server based on the customer's request. The print shop operator commits the main job ticket for execution (step (S23). Alternatively, in a more automated system, the server may automatically commit the customer-submitted job for execution without operator intervention, in which case steps S22 and S23 can be combined. After the main job is committed for execution, the server generates a plurality of sub-job tickets based on the main job ticket and other considerations, and stores them in the server database associated with the main job ticket (step S24). When generating the sub-job tickets, the server also determines the order in which the sub-jobs are executed. For example, in the color split example given above, if page merging is to be carried out on one of the two printers, then the other print sub-job should be executed first, and the sub-job that carries out the merging should be executed after the first sub-job has finished. This order and timing can be achieved by the server; in other words, the server will not submit the second sub-job to the second printer until it is informed that the first sub-job has completed and its output has been transported to the paper inserter unit of the second printer. Alternatively, the server may submit both sub-jobs to the respective printers, but with a “hold” status on the second sub-job, so that the operator can start the second sub-job after he transports the output of the first sub-job to the paper inserter unit of the second printer. In the banner page printing and off-line instruction sheet printing examples, the customer's document is printed first, and the banner page or off-line instruction sheet is printed afterwards.

After the server generates the sub-job tickets, it starts execution of the sub-job tickets (i.e. submitting them to the printers) according to the proper order that has been determined (step S25). The server monitors the execution and completion of each sub-job and updates the status of the main job accordingly, and displays the main job status on the user interface of the client (step S26). For example, in the color split case, the main job ticket (“main JT”) status can be determined based on the sub JT status in the following manner:

TABLE 2

| | Main JT | Sub JT 1 Status | Sub JT-2 Status |
|---|---|---|---|
| Operation | Status | (Color sub-job) | (BW sub-job) |
| 1. Main JT Inbox at | Init | | |
| start | | | |
| 2. Main JT submitted to | Start | | |
| color split process | | | |
| 3. Color sub-job | InProgress/ | Waiting/ | |
| printing | Stopped | Printing/ | |
| | | Stopped/ | |
| | | Complete | |
| 4. BW sub-job printing | InProgress/ | | Waiting/ |
| | Stopped | | Printing/ |
| | | | Stopped/ |
| | | | Complete |
| 5. Main JT done | Complete/ | | |
| | Cancel | | |

The monitoring of each sub-job may be done in the same way conventional print shop management systems monitor print jobs. Updating the main job ticket status is easily accomplished because the main job ticket and the corresponding sub-job tickets are stored in the database in association with each other. Once all the all sub-jobs are completed, the sub-job tickets are closed, and the server changes the status of the main job displayed on the user interface to a “complete” status (step S27). This fulfills the original print request submitted by the customer.

From the above description, it can be seen that the customer's print request, which indicates what is to be produced, is used to generate a main job ticket. The server then interprets the customer's request in the main job ticket to generate a sequence of server-defined sub-job processes. Each sub-job process is defined by a sub-job ticket which is a set of parameters that define its execution. Additionally, the server maintains the execution sequence of the sub-job processes in a database relationship table (e.g. the sub-job ticket ordering table described earlier).

Using the above method, the original print job submitted by the customer appears as one job (the main job ticket) on the client's user interface display throughout the execution. The overall processing status of the print job is provided to the user via the user interface display by identifying the main job ticket and its status, and when all sub jobs are complete, the main job ticket is displayed as being complete.

While the embodiments have been described as being applied in a print shop environment, the invention is not limited to any physical setting of a shop, and can be applied to a print shop system having a distributed setting where printers at different locations are connected to a server.

It will be apparent to those skilled in the art that various modification and variations can be made in the print shop management method and apparatus of the present invention without departing from the spirit or scope of the invention. Thus, it is intended that the present invention cover modifications and variations that come within the scope of the appended claims and their equivalents.

What is claimed is:

1. A method for managing print jobs in a print shop system, the print shop system including a plurality of document handling machines, the method being implemented on a server connected to the document handling machines, the method comprising:
receiving a print request from a customer;
obtaining a main job ticket for the print request;
generating, based on the main job ticket, a plurality of sub-job tickets each defining a sub-job to be executed by a document handling machine, the plurality of sub-jobs collectively fulfilling the received print request;
storing the main job ticket and the sub-job tickets in a database in association with each other; and
executing the plurality of sub-jobs defined by the plurality of sub-job tickets.

2. The method of claim 1, wherein the print shop system further includes at least one client computer supporting a user interface, the method further comprising:
monitoring the status of each sub job;
generating a status of the main job ticket based on the status of the sub jobs; and
communicating the status of the main job ticket to a user via the user interface.

3. The method of claim 2, wherein a status of the main job ticket indicates that the print request has been fulfilled.

4. The method of claim 2, further comprising:
assigning an identifier to the main job ticket;
wherein the status of the main job ticket is communicated to the user using the identifier.

5. The method of claim 4, further comprising:
assigning an identifier to each of the sub-job tickets, the identifier being based on the identifier for the main job ticket.

6. The method of claim 5, wherein the identifier for each sub-job ticket is assigned using the identifier of the main job ticket as a prefix.

7. The method of claim 1, wherein the plurality of sub-job tickets are generated by applying at least one splitting condition to the main job ticket.

8. The method of claim 1, wherein the plurality of sub-job tickets include a first sub-job ticket for printing color pages of a document received from the customer on a color printer and a second sub-job for printing black and white pages of the document on a black and white printer.

9. The method of claim 1, wherein the plurality of sub-job tickets include a first sub-job ticket for printing a document received from the customer and a second sub-job ticket for printing a banner page.

10. The method of claim 1, wherein the plurality of sub-job tickets includes a first sub-job ticket for printing a document received from the customer and a second sub-job ticket for printing an off-line instruction sheet.

11. A computer program product comprising a computer usable medium having a computer readable code embodied therein for controlling a data processing apparatus, the computer readable program code configured to cause the data processing apparatus to execute a process for managing print jobs in a print shop system, the print shop system including a plurality of document handling machines, the process comprising the steps of:
receiving a print request from a customer;
obtaining a main job ticket for the print request;
generating, based on the main job ticket, a plurality of sub-job tickets each defining a sub-job to be executed by a document handling machine, the plurality of sub-jobs collectively fulfilling the received print request;
storing the main job ticket and the sub-job tickets in a database in association with each other; and
executing the plurality of sub-jobs defined by the plurality of sub-job tickets.

12. The computer program product of claim 11, the process further comprising:
monitoring the status of each sub job;
generating a status of the main job ticket based on the status of the sub jobs; and
communicating the status of the main job ticket to a user.

13. The computer program product of claim 12, wherein a status of the main job ticket indicates that the print request has been fulfilled.

14. The computer program product of claim 12, the process further comprising:
assigning an identifier to the main job ticket;
wherein the status of the main job ticket is communicated to the user using the identifier.

15. The computer program product of claim 14, the process further comprising:
assigning an identifier to each of the sub-job tickets, the identifier being based on the identifier for the main job ticket.

16. The computer program product of claim 15, wherein the identifier for each sub-job ticket is assigned using the identifier of the main job ticket as a prefix.

17. The computer program product of claim 11, wherein the plurality of sub-job tickets are generated by applying at least one splitting condition to the main job ticket.

18. The computer program product of claim 11, wherein the plurality of sub-job tickets include a first sub-job ticket for printing color pages of a document received from the customer on a color printer and a second sub-job for printing black and white pages of the document on a black and white printer.

19. The computer program product of claim 11, wherein the plurality of sub-job tickets include a first sub-job ticket for printing a document received from the customer and a second sub-job ticket for printing a banner page.

20. The computer program product of claim 11, wherein the plurality of sub-job tickets includes a first sub-job ticket for printing a document received from the customer and a second sub-job ticket for printing an off-line instruction sheet.
